(19) United States
(12) Patent Application Publication
(10) Pub. No.: US 2004/0036191 A1
(43) Pub. Date: Feb. 26, 2004

(54) Method of making a fireproof panel

(76) Inventors: Philip A. Rodda, Redmond, OR (US); Terry A. Turner, Madras, OR (US)

Correspondence Address: KOLISCH HARTWELL, P.C., 520 S.W. YAMHILL STREET, SUITE 200, PORTLAND, OR, 97204, US

(21) Appl. No.: 10/427,464

(22) Filed: Apr. 30, 2003

Related U.S. Application Data
(60) Provisional application No. 60/377,293, filed on Apr. 30, 2002.
(60) Provisional application No. 60/379,601, filed on May 10, 2002.

(51) Int. Cl. B27N 3/00; D04H 1/00

(52) U.S. Cl. 264/109

(57) ABSTRACT

A method of making a wood-based fireproof panel by combining fire-resistant chemicals with wood fibers in a dry process is provided.

### CROSS-REFERENCE TO RELATED APPLICATIONS

This application claims priority under 35 U.S.C. § 119 and applicable foreign and international law of the following U.S. provisional patent applications, which are hereby incorporated by reference in their entirety for all purposes: Serial No. 60/377,293 filed Apr. 30, 2002; and Serial No. 60/379,601 filed May 10, 2002.

### FIELD OF THE INVENTION

The invention relates to fireproof wood-based products and materials. In particular, the invention provides dry processes for making wood composite panels that will not support combustion.

### BACKGROUND OF THE INVENTION

Recent environmental regulations and depletion of old-growth timber have made it increasingly difficult and expensive for manufacturers to obtain high-quality lumber for use in wood products. This has resulted in widespread and common use of alternative structural products such as wood composite materials for construction. However, wood composite materials, like lumber, suffer from the significant problem that they are readily combustible.

There are many manufacturers of particle board and medium density fiber board in the United States and throughout the world. One of the biggest applications for particle board and fiber board is in buildings. Wood composite panels are used, for example, in internal and external walls, doors, framing for doors and windows, floors, molding, furniture, cabinets, etc. Fire danger is a constant concern, with wood-based building materials. Some composite wood products resist fire for an insufficiently short period of time before combusting. Another problem with fire-resistant panels may occur when the level of chemicals is too high relative to the amount of wood fiber resulting in structural weakness. There is a big need for improved methods of rendering wood-based materials such as particle board and fiber board fireproof.

### SUMMARY OF THE INVENTION

The invention provides compositions and methods of rendering wood-based structural members fireproof. A method of making a fireproof panel may be carried out by mixing aluminum trihydrate (ATH) with a compound selected from the group consisting of Na₄O₄Si, metacaolin clay, CEASE FIRE, NH₄H₂PO₄ (MAP), diatomaceous earth, and mixtures thereof, together with wood particles, preferably fibers, to form a first mixture. A phenolic resin is added, for example, by spraying the first mixture. The mixture is then pressed into an appropriate panel form dimensioned according to the intended use for the product. The panel form is then heated until the phenolic resin is substantially cured.

In a preferred mode of carrying out the invention, a mixture of ATH and NH₄H₂PO₄ (MAP) is combined with wood fibers. The amount of the mixture may be approximately 30% of the weight of the wood particles.

### DESCRIPTION OF THE INVENTION

The invention has been practiced in relation to procedures for manufacturing wood boards such as particle board and fiber board. Additionally, the invention may be used to render other combustible structural members resistant to fire damage. Fiber board is produced sometimes using a wet slurry process. Other companies use a dry process to bind wood particles (furnish) into a board form. These products typically combust readily when exposed to flame. Several manufacturers incorporate borates into fiber board. These boards may achieve a modest fire rating, but will eventually ignite when exposed to constant flame.

The invention involves incorporation of a fire-resistant material into a wood-based product. For example, materials that may work well for this process include aluminum trihydrate (ATH), sodium silicate (Na₄O₄Si), metacaolin clay, CEASE FIRE, magnesium oxide (MgO), and mono ammonium phosphate (NH₄H₂PO₄) (MAP). The fire resistant chemical(s) or compound(s) may be incorporated into the fire board by mixing it with particles prior to binding the particles in a finished board. Alternatively, the fire resistant material may be added superficially, for example, by coating it on the surface of a wood-based product.

A method, according to the invention, has resulted in a board which will not support combustion when exposed to 2200° F. The board chars and may show slight intumescence. In spite of the duration of exposure it will not burn, i.e., support combustion. The method has been demonstrated in a dry fabrication process. In this process, phenolic resin is misted into the tumbling furnish (graded sawdust) at a rate of 4.3% by weight of furnish. It is then forced air dried and pressed at high temperature to bring the moisture content to approximately 8%.

### EXAMPLES

### Example 1

In test number one, several 6″×6″ “mat” sections were removed from the caul plate. This furnish was weighed accurately. In one test sample, for example, the furnish weighed 149 grams. Next, 44.7 grams of a dry fireproofing powder called CEASE-FIRE (distributed by Cote-L Industries in Teaneck, N.J.) was added to the furnish and mixed thoroughly. The resultant mixture was reinserted into the mat and the panel was sent into the hot press at about 385° F. for 1 minute, 40 seconds.

### Example 2

In test number two, a 12″×12″ section of mat was removed. This sample was weighed precisely, and determined to be 10.76 oz. To this furnish, 1.29 oz of sodium silicate “G” powder and 0.32 oz. of metacaolin clay powder (totaling 1.61 oz), and 1.61 oz. of CEASE-FIRE were added to the furnish and mixed thoroughly. The resultant mixture was reinserted into the mat, and the panel was pressed as described above.

After the boards came off the line, the treated sections were removed and subjected to direct flame from a propane torch. The section from test one including CEASE-FIRE resisted fire damage in comparison to the unmodified board. The treated section from test two performed even better than the treated board from test one.

### Example 3

Fifteen pounds of material was taken from a 4′×8′ mat of furnish. 1.5 pounds of CEASE-FIRE and 1.5 pounds of TECTONITE HT was added to the furnish. The material was then reinserted into the mat and pressed.

### Example 4

Three pounds of TECTONITE HT was added to 15 pounds of furnish taken from a 4′×8′ section of mat. The material was then reinserted into the mat and pressed.

### Example 5

2.25 pounds of TECTONITE HT and 0.75 pounds of CEASE-FIRE was added to 15 pounds of furnish taken from a 4′×8′ section of mat. The material was then reinserted into the mat and pressed.

### Example 6

1.68 pounds of TECTONITE HT and 0.562 pounds of CEASE-FIRE was added to 15 pounds of furnish taken from a 4′×8′ section of mat. The material was then reinserted into the mat and then pressed.

### Example 7

A mixture of ATH and halogenated phosphates was mixed with furnish. The amount of chemical mixture was 30% by weight of the furnish. A binder was added for pressing and feeding into a panel form as discussed above.

### Example 8

In another formulation ATH and MAP are combined with sawdust. The combined weight of ATH and MAP is about 30% by weight of the sawdust. The ratio of the two chemicals is approximately 25% ATH and 75% MAP.

In this application the terms “about” or “approximately” should be interpreted to mean plus or minus 10% of the respective figure.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

We claim:

1. A method of making a fireproof panel comprising
mixing aluminum trihydrate (ATH) and a compound selected from the group consisting of Na₄O₄Si, metacaolin clay, CEASE FIRE, NH₄H₂PO₄ (MAP), diatomaceous earth, and mixtures thereof with wood particles to form a first mixture,
adding a phenolic resin to the first mixture,
pressing the first mixture into a panel form, and
heating the panel form until the phenolic resin is substantially cured.

2. The method of claim 1, wherein the compound comprises a phosphate.

3. The method of claim 1, wherein the ATH and the compound together constitute about 30% by weight of the sawdust.

4. The method of claim 1, wherein the heating step is performed during the pressing step.

5. The method of claim 1, wherein the compound comprises MAP.

6. The method of claim 1, wherein the ratio of ATH to compound is about 1 to 3 by weight.

7. The method of claim 1, wherein the amount of ATH is between about 15% to 90% of the combined weight of the ATH and the compound.

8. The method of claim 1, wherein the compound comprises MAP in an amount of about 10% to 85% of the combined weight of the ATH and the compound.

9. The method of claim 1, wherein the amount of compound is between about 10% to 85% of the combined weight of the ATH and the compound.

10. The method of claim 1, wherein the amount of phenolic resin is approximately 2-5% by weight of the sawdust.

11. The method of claim 1, wherein the panel form is heated to approximately 350° F. to 400° F. during the pressing step.

12. The method of claim 1, wherein the wood particles comprise wood fibers.

13. The method of claim 1, wherein the panel form is dimensioned for use in structure selected from the group comprising a wall, a floor, a door, framing for a door or window, cabinets, counters and furniture items.

14. The method of claim 1, wherein the panel form is embossed.
